(19) United States
(12) Patent Application Publication
(10) Pub. No.: US 2009/0030870 A1
(43) Pub. Date: Jan. 29, 2009

(54) ERROR PROPAGATION IN OBJECT-RELATIONAL MAPPING PLATFORM

(75) Inventors: Zlatko Michailov, Redmond, WA (US); Colin J. Meek, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/829,214

(22) Filed: Jul. 27, 2007

(51) Int. Cl. G06F 7/00

(52) U.S. Cl. 707/1

(57) ABSTRACT

Systems and methods that present error messages in context of entities to application that issue rich queries, via an error propagation component. Accordingly, errors can be built up along the way (e.g., context/nesting), wherein troubleshooting processes can drill back down to the original cause. Hence, the error messages can be presented in the context of entities, as opposed to the underlying store.

### BACKGROUND

Advent of a global communications network such as the Internet has facilitated exchange of enormous amounts of information. Additionally, costs associated with storage and maintenance of such information has declined, resulting in massive data storage structures. Hence, substantial amounts of data can be stored as a data warehouse, which is a database that typically represents business history of an organization. For example, such stored data is employed for analysis in support of business decisions at many levels, from strategic planning to performance evaluation of a discrete organizational unit. Such can further involve taking the data stored in a relational database and processing the data to make it a more effective tool for query and analysis.

Accordingly, data has become an important asset in almost every application, whether it is a Line-of-Business (LOB) application utilized for browsing products and generating orders, or a Personal Information Management (PIM) application used for scheduling a meeting between people. Applications perform both data access/manipulation and data management operations on the application data. Typical application operations query a collection of data, fetch the result set, execute some application logic that changes the state of the data, and finally, persist the data to the storage medium.

Traditionally, client/server applications relegated the query and persistence actions to database management systems (DBMS), deployed in the data tier. If data-centric logic, it is coded as stored procedures in the database system. The database system operated on data in terms of tables and rows, and the application, in the application tier, operated on the data in terms of programming language objects (e.g., Classes and Structs). The mismatch in data manipulation services (and mechanisms) in the application and the data tiers was tolerable in the client/server systems. However, with the advent of the web technology (and Service Oriented Architectures) and with wider acceptance of application servers, applications are becoming multi-tier, and more importantly, data is now present in every tier.

In such tiered application architectures, data is manipulated in multiple tiers. In addition, with hardware advances in addressability and large memories, more data is becoming memory resident. Applications are also dealing with different types of data such as objects, files, and XML (eXtensible Markup Language) data, for example.

In hardware and software environments, the need for rich data access and manipulation services well-integrated with the programming environments is increasing. One conventional implementation introduced to address the problems above is a data platform. The data platform provides a collection of services (mechanisms) for applications to access, manipulate, and manage data that is well integrated with the application programming environment. In general, such conventional architecture fail to adequately supply: complex object modeling, rich relationships, the separation of logical and physical data abstractions, query rich data model concepts, active notifications, better integration with middle-tier infrastructure, and the like. Moreover, in these environments errors can build up context (e.g., nest) and become difficult to trace and unwrap to locate the error source.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for systems and methods that present error messages in context of entities to application that issue rich queries, via an error propagation component. Such error propagation component can preserve original context for errors and operates across abstraction boundaries, to map across entities model to relational model. Accordingly, errors (e.g., concurrency errors from modifying underlying database, and associated with operations that manipulate data of the underlying database) can be built up along the way (e.g., context/nesting), wherein troubleshooting processes can drill back down to the original cause and unwrap the context in a reverse order, hence the error messages are presented in the context of entities and not the underlying store.

In a related aspect, the error propagation component can further include a tracking component (that establishes a trail for the data to readily facilitate identifying where such data has originated from), and a reconstruction component (that can further reconstruct the context), wherein optimizations can be employed to minimize information required to flow, and efficiently employ memory resources. Context information can attach to predetermined values (e.g. entity values mapped to every table) as opposed to every individual values, wherein the context information is subject to propagation behaviors, such as modification, merging, splitting, and elimination. The context carriers can also be chosen based on mapping specification.

In a related methodology, initially an application defines an operation (e.g., associated with queries) in terms of entity concept. For example, the operation can be in form of inserts, deletes, updates; or a query that can then be represented by an abstract class in form of a canonical representation, which has metadata tied therewith. In addition, such metadata can contain information about where data has originated, to designate a return address and identify which pieces of data travel together. Subsequently, as operators interact with the data the return address can be interpreted at each stage and upon occurrence of an error, respective return addresses can be unraveled. Next, the data that contributed to the operation that failed can be identified by walking through the graph of return addresses.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an error propagation component in accordance with an aspect of the subject innovation.

FIG. 2 illustrates a system that incorporates an error propagation component according to a further aspect of the subject innovation.

FIG. 3 illustrates a tracking component as part of an error propagation component in accordance with an aspect of the subject innovation.

FIG. 4 illustrates a particular methodology of presenting error messages in context of entities.

FIG. 5 illustrates a further methodology of propagating errors according to a further aspect of the subject innovation.

FIG. 6 illustrates an exemplary implementation of a system that can employ an error propagation component according to an aspect of the subject innovation.

FIG. 7 illustrates an error propagation component that facilitates presentation of errors in an entity model, during a transformation between a rich object structure and a relational store dialect.

FIG. 8 illustrates an artificial intelligence (AI) component that facilitates inferring and/or determining when, where, how to generate an error message in accordance with an aspect of the subject innovation.

FIG. 9 illustrates an exemplary environment for implementing various aspects of the subject innovation.

FIG. 10 is a schematic block diagram of a sample-computing environment that can be associated with an error propagation component according to an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

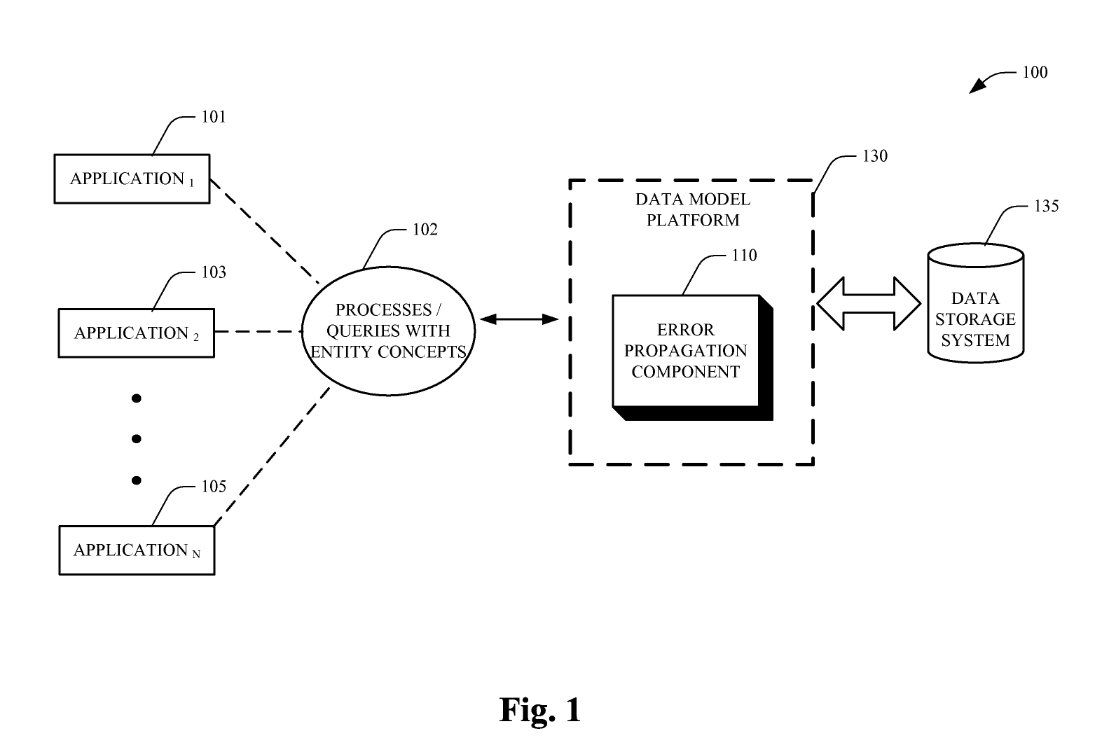

FIG. 1 illustrates a block diagram of a system 100 that employs an error propagation component 110 that presents error messages to applications 101, 103, 105 in context of entity models. The system 100 enables processes (e.g., functions or acts that affect an underlying storage provider) such as queries that employ an Entity Data Model (EDM) having entity concepts, to be executed against relational stores that do not typically support such structure. Typically, the EDM is an extended relational data model that supports basic relational concepts, rich types with inheritance, and relationships. Users need the ability to issue rich queries against their data expressed in terms of the EDM. As illustrated in FIG. 1, the query with entity concepts 102 can be associated with a data model platform 130 such as a base class library that is employed to access data in a relational database system (e.g. an ADO.net framework). An exemplary data model platform 130 and related data support mechanisms can be implemented into a set of technologies such as the Active X Data Objects for managed code (ADO.NET) platform. Such ADO.net platform can be designed to provide consistent access to data sources such as a Database Management Server (e.g., MICROSOFT® SQL Server) as well as data sources that can be exposed through Object Linking and Embedding for Databases (OLE DB) and Extensible Markup Language (XML). Data-sharing consumer applications can also employ ADO.NET to connect to these data sources and retrieve, manipulate, and update data. The system 100 facilitates translation of a rich object structure into flat relational constructs, which can then be executed by a relational store associated with the data storage system 135 (e.g., translation into Structured Query Language (SQL) and/or other dialect of the data storage system 135).

The data storage system 135 can be a complex model based at least upon a database structure, wherein an item, a sub-item, a property, and a relationship are defined to allow representation of information within a data storage system as instances of complex types. For example, the data storage system 135 can employ a set of basic building blocks for creating and managing rich, persisted objects and links between objects. An item can be defined as the smallest unit of consistency within the data storage system 135, which can be independently secured, serialized, synchronized, copied, backup/restored, and the like. Such item can include an instance of a type, wherein all items in the data storage system 135 can be stored in a single global extent of items. The data storage system 135 can be based upon at least one item and/or a container structure. Moreover, the data storage system 135 can be a storage platform exposing rich metadata that is buried in files as items. The data storage system 135 can include a database, to support the above discussed functionality, wherein any suitable characteristics and/or attributes can be implemented. Furthermore, the data storage system 135 can employ a container hierarchical structure, wherein a container is an item that can contain at least one other item. The containment concept is implemented via a container ID property inside the associated class. A store can also be a container such that the store is a physical organizational and manageability unit. In addition, the store represents a root container for a tree of containers with in the hierarchical structure. As such, queries defined by applications in terms of entity concepts can readily be employed in conjunction with relational data stores. Similarly, results obtained from executing the query can be converted back to a form understandable by the application. Accordingly, a form that queries can be written is abstracted, wherein data can be modeled in same manner as employed in associated applications 101, 103, 105 (1 to N, where N is an integer)—so that queries need not be written in a manner that data is stored in the database, but rather the abstraction. The error propagation component 110 can preserve original context for errors and operates across abstraction boundaries, to map across entities model to relational model. Accordingly, errors (e.g., concurrency errors from modifying underlying database) can be built up along the way (e.g., context/nesting), wherein troubleshooting processes can drill back down to the original cause and unwrap the context in a reverse order, hence the error messages are presented in the context of entities concepts 102 and not the underlying data storage system 135.

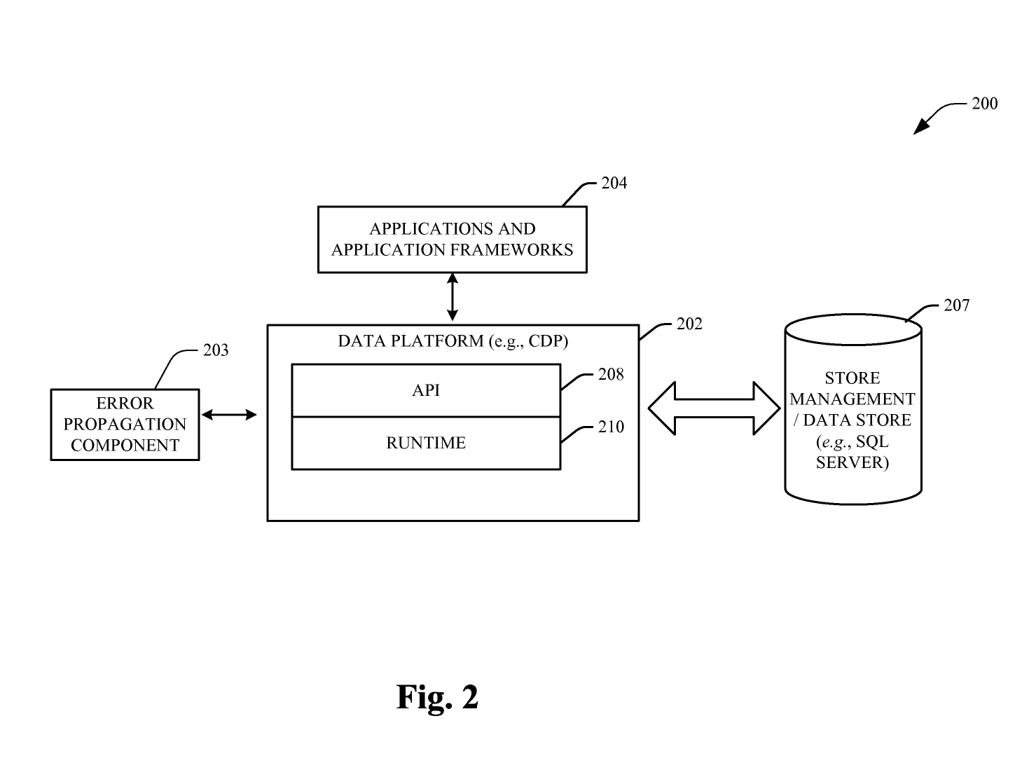

FIG. 2 illustrates a system 200 that implements an error propagation component 200 in accordance with an aspect of the subject innovation. The data platform 202 can function as a platform that provides a collection of services/mechanisms for applications to access, manipulate, and manage data that is integrated with the application programming environment. In general, a data platform is a platform that provides a collection of services/mechanisms for applications to access, manipulate, and manage data that is well integrated with the application programming environment. For example, the data model platform 202 can be a common data platform (CDP) and/or Entity Data Model that provides data services, which are common across a variety of application frameworks (e.g., PIM (Personal Information Manager) framework, and LOB (Line-of-Business) framework). The range of applications include end-user applications such as Explorer, Mail, and Media applications; Knowledge Worker applications such as Document Management and Collaboration applications; LOB applications such as ERP (Enterprise Resource Planning) and CRM (Customer Relationship Management); Web Applications and System Management applications. In such system 200, a query can be represented by an abstract class in form of a tree structure with nodes, which has metadata tied therewith. Moreover, if an error is encountered, the error propagation component 203 can preserve original context for such errors across abstraction boundaries, to map across entities model to relational model. Hence, errors during translation into Structured Query Language (SQL) and/or direct comprehension by an associated database (e.g., typically without translation into a textual format), can be presented in the entity model to applications that issues such queries.

According to one particular aspect, the CDP 202 provides data services that are common across the application frameworks and end-user applications associated therewith. The CDP 202 further includes an API 208 that facilitates interfacing with the applications and application frameworks 204, and a runtime component 210, for example. The API 208 provides the programming interface for applications using CDP in the form of public classes, interfaces, and static helper functions. The CDP runtime component 210 is a layer that implements the various features exposed in the public API layer 208. It implements the common data model by providing object-relational mapping and query mapping, enforcing data model constraints, and the like. More specifically, the CDP runtime 210 can include: the common data model component implementation; a query processor component; a sessions and transactions component; an object cache, which can include a session cache and an explicit cache; a services component that includes change tracking, conflict detection; a cursors and rules component; a business logic hosting component; and a persistence and query engine, which provides the core persistence and query services. Internal to persistence and query services are the object-relational mappings, including query/update mappings.

The store management layer 207 provides support for core data management capabilities (e.g., scalability, capacity, availability and security), wherein the CDP 202 supports a rich data model, mapping, querying, and data access mechanisms for the application frameworks 204. The CDP mechanisms are extensible so that multiple application frameworks 204 can be built on the data platform. The application frameworks 204 are additional models and mechanisms specific to application domains (e.g., end-user applications and LOB applications). Such layered architectural approach supplies several advantages, e.g., allowing each layer to innovate and deploy independently and rapidly.

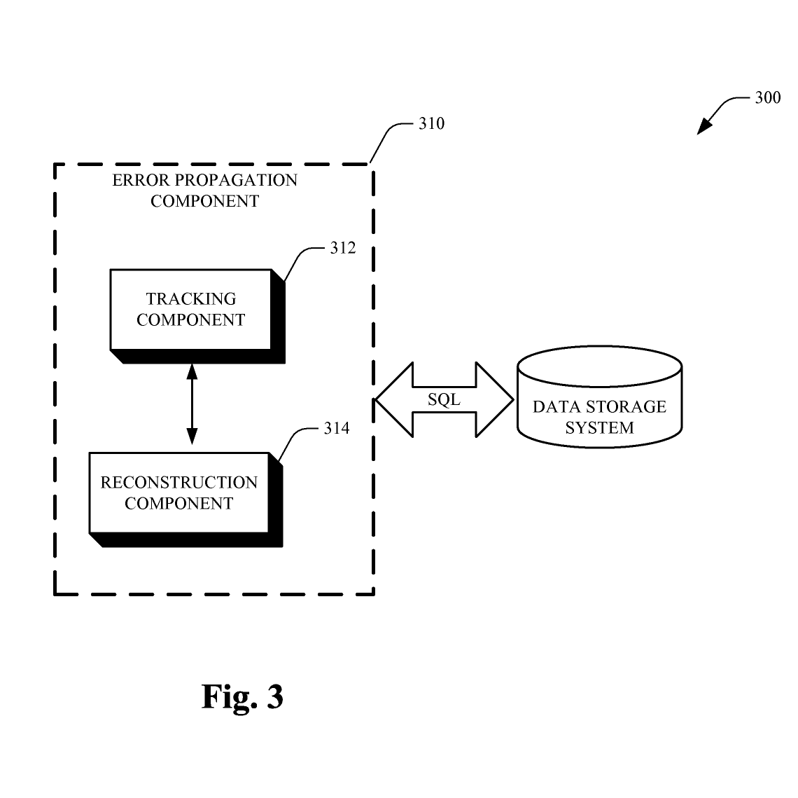

FIG. 3 illustrates a particular error propagation component 310 in accordance with a further aspect of the subject innovation. As illustrated, the error propagation component 310 can include a tracking component 312 and a reconstruction component 314. The tracking component 312 establishes a trail for the data to readily facilitate identifying where such data has originated. Likewise, the reconstruction component 314 can further reconstruct the context, wherein optimizations can further be employed to minimize information required to flow, and efficiently employ memory resources of the system 300. Context information can attach to predetermined values (e.g. entity values mapped to every table)—as opposed to every individual values—wherein the context information is subject to propagation behaviors, such as modification, merging, splitting, and elimination. The context carriers can also be chosen based on mapping specification.

As such, queries defined by applications in terms of entity concepts can readily be employed in conjunction with relational data stores. Similarly, errors encountered from executing the query can be converted back to a form understandable by the application. Accordingly, a writing form of the queries can be abstracted, wherein data can be modeled in same manner as employed in associated applications (e.g., queries need not be written in a manner that data is stored in the database, but can be supplied in an abstract form.)

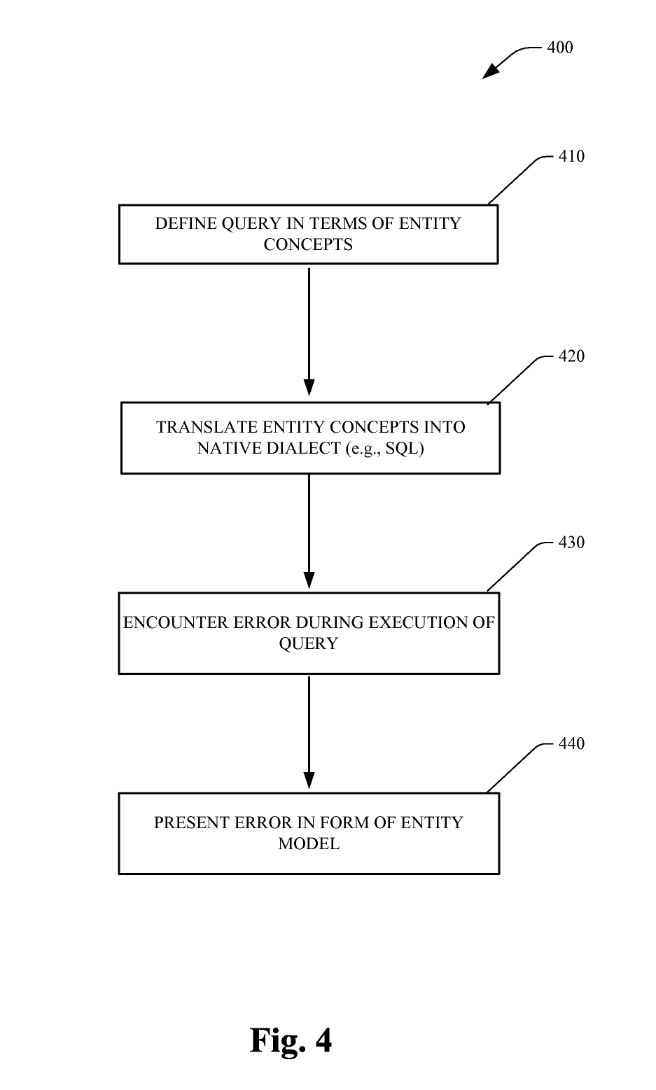

FIG. 4 illustrates a methodology 400 of presenting error messages in context of entities in accordance with an exemplary aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described.

Initially, and at 410 a query is defined in terms of entity concepts. Such entity concepts can implement structure/object oriented concepts such as inheritance, nesting, and the like. For example, the query can be parsed to facilitate creation of nodes for a tree structure, which functions as a canonical tree representation of the query. As such, a plurality of nodes can be obtained that form the canonical representation, which represent a structured form of the query. Moreover, the nodes can represent various relational and Entity constructs and operations such as expressions. Next and at 420, the generated command canonical representation can be translated into query language and native dialect of the store provider. At 430 errors are encountered, which can include concurrency errors from modifying underlying database, for example. Such errors can be built up along the way (e.g., context/nesting), wherein troubleshooting processes can drill back down to the original cause and unwrapping the context in a reverse order, hence the error messages are presented in the context of entities at 440 (e.g., as opposed to displaying such errors in form of the underlying store.)

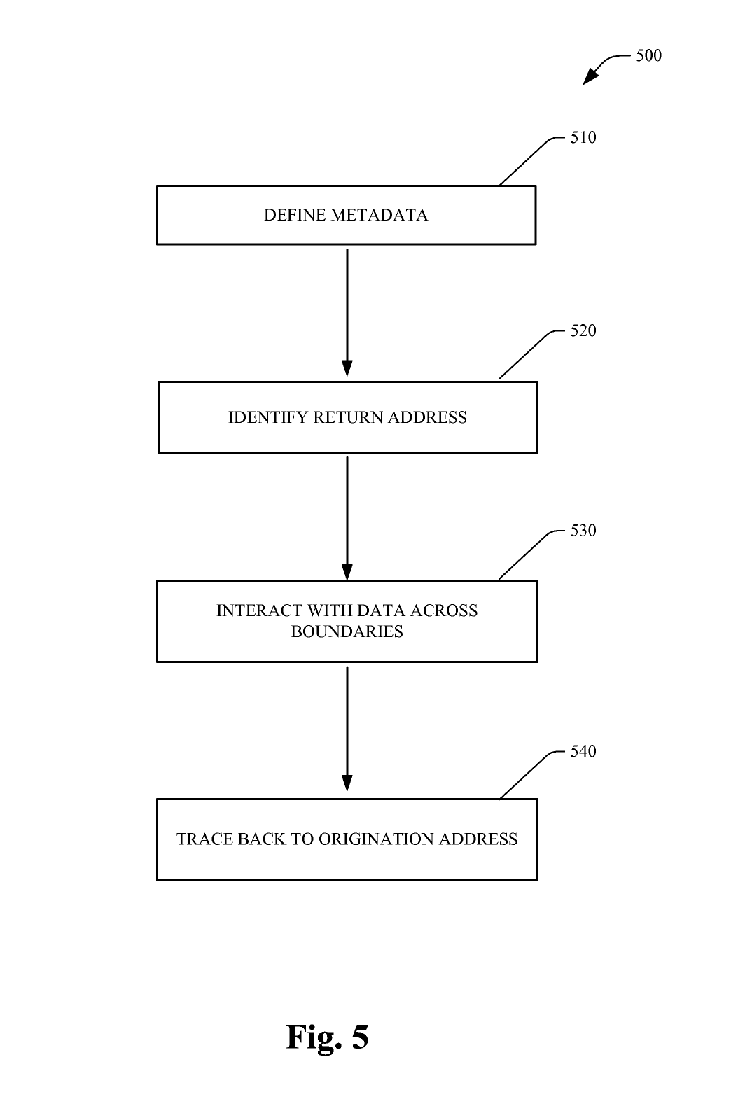

FIG. 5 illustrates a related methodology 500 in accordance with a further aspect of the subject innovation. Initially and at 510, metadata is defined in relation to entity objects that can contain information about where data has originated. Moreover, column maps or assembly of instructions can be incorporated as part of such metadata to identify a return address at 520, and designate which pieces of data travel together, for example. Accordingly, at 530 operators can interact with the data, wherein the return address can be interpreted at each stage and upon occurrence of an error, respective return addresses can be unraveled. At 540, the data that contributed to the operation that failed can be identified by walking through the graph of return addresses.

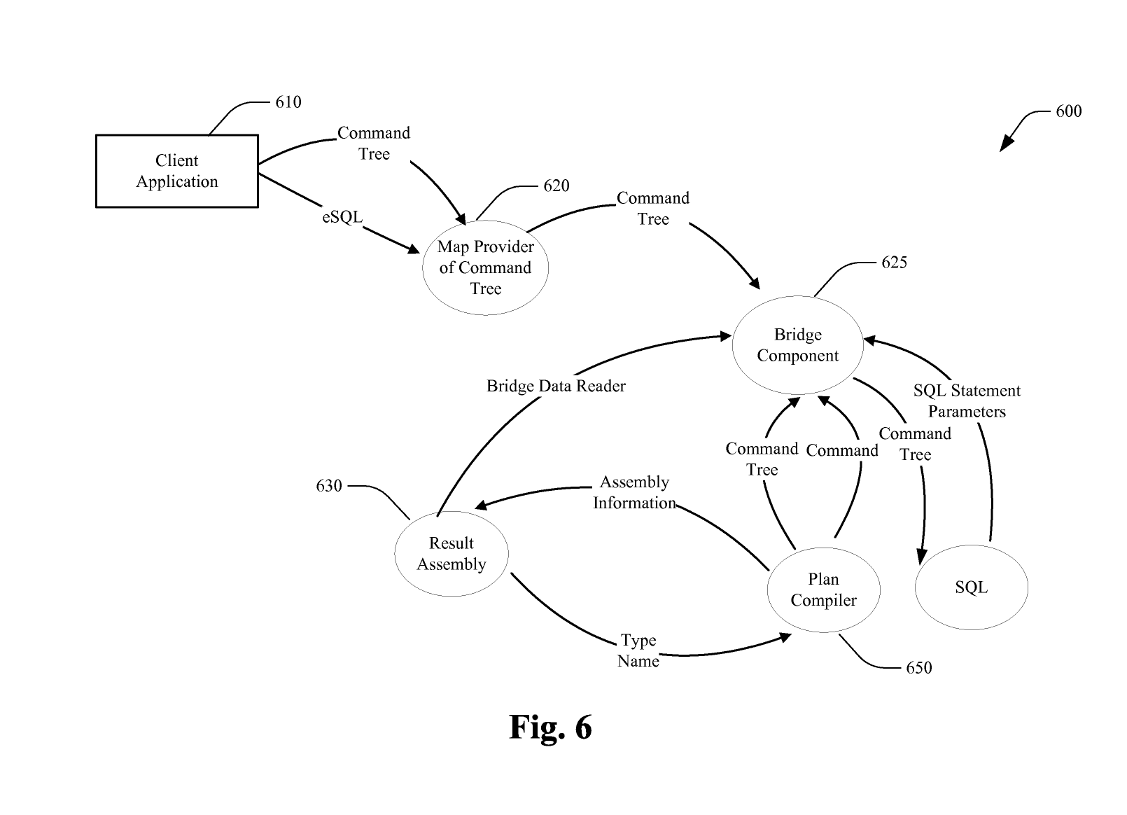

FIG. 6 illustrates an exemplary query flow through a CDP that is associated with an error propagation component in accordance with an aspect of the subject innovation. Initially an application can issue a query against map provider as an eSQL query. For example, the client application 610 issues a query against the map provider component 620, or as an eSQL query, Canonical Query Tree (CQT) or as Language Integrated Query (LINQ) expressions. The Map Provider component 620 can subsequently call the eSQL parser 630 to convert the eSQL into a CQT as required. Moreover, the Map Provider Component 620 can also convert the LINQ expressions into CQTs. The CQT can then be returned to the Map Provider component 620 that creates a Command Definition from the CQT, wherein a Plan Compiler 650 can be called to perform transformations and simplifications on the expressions in the CQT. The result of such transformations can be in form of a number of simplified CQTs that represent the original CQT; as well as assembly information needed on the results assembly component to stitch results back together post execution (not shown). The CQT(s) can subsequently be passed to the Storage Provider. The Storage provider can then walk the CQTs and translates the expressions (nodes of the tree) into its native (SQL) dialect.

As illustrated in FIG. 6, the bridge component 625 facilitates translation of a rich object structure into flat relational constructs, wherein a canonical representation of a query (e.g., a command tree) is received and subsequently executed by the relational store. The SQL can then be executed. Accordingly, an object model representation of a query in a given metadata space that can further be employed to represent Query, Update, Insert and Delete commands. Moreover, any errors encountered during related operation can be traced back to its original address. For example, a query can be represented by an abstract class in form of a canonical representation, which has metadata tied therewith. Such metadata can contain information about where data has originated, to identify a return address and identify which pieces of data travel together. Hence, as operators interact with the data the return address can be interpreted at each stage and upon occurrence of an error, respective return addresses can be unraveled. Next, the data that contributed to the operation that failed can be identified by walking through the graph of return addresses.

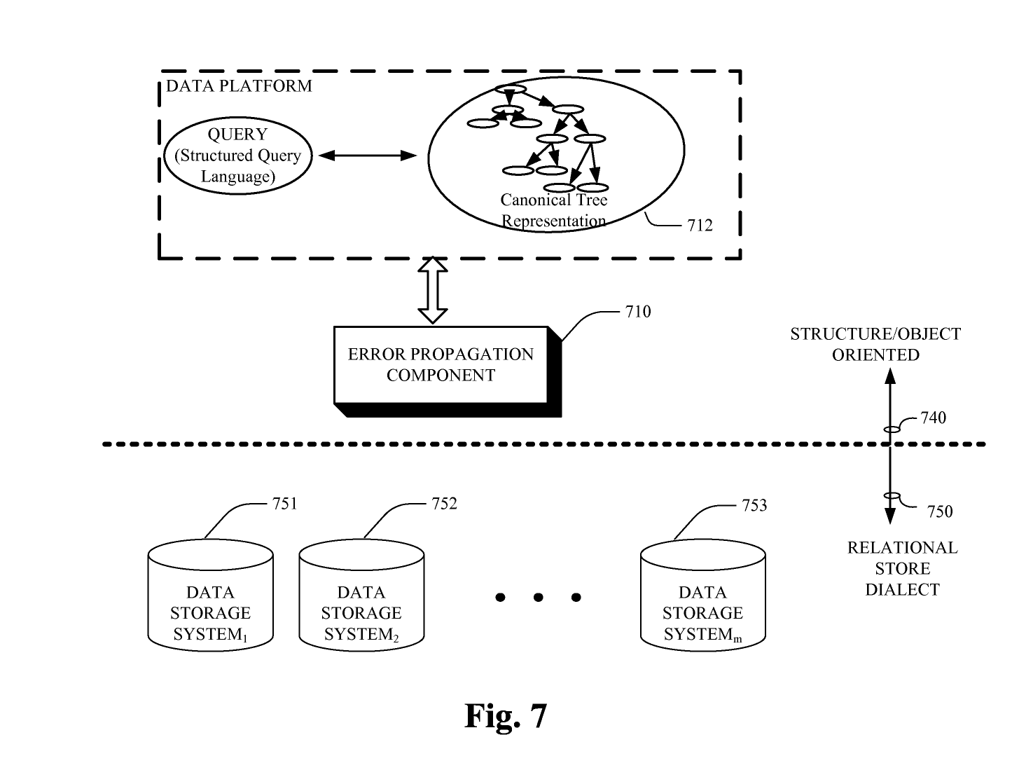

FIG. 7 illustrates an error propagation component 710 that facilitates presentation of errors in an entity model, during a transformation between a rich object structure 740 (e.g., on the client side) and a relational store dialect (the data storage provider 751, 752, 753, 1 thru m where m is an integer) associated with the relational store dialect. It is to be appreciated that the subject innovation is not limited to such data models, and typically, errors between other models can be propagated in accordance with the subject innovation. As explained earlier, the error propagation component 710 can supply a standard manner of error representation for errors due to mapping, transformation, encapsulation, concurrency issues of storage provider 751, 752, 753. Accordingly, errors obtained from executing the query can be converted back to a form understandable by the application. Thus, a form that errors are presented can be abstracted, wherein data can be modeled in same manner as employed in associated applications (e.g., errors need not be presented in a manner that data is stored in the database, but rather the abstraction.)

For example, user Alice attempts to add a new product category to the Northwind ObjectContext using a CategoryID colliding with an existing primary key value in the store, as indicated below:

NorthwindContainer northwind = new
NorthwindContainer(connection, workspace);
...
Category category = new Category(1);
category.CategoryName = “Foo”;
northwind.Categories.Add(category);
...
northwind.SaveChanges( ); // failure

The exception supplied from the store can include:

System.Data.SqlClient.SqlException: Violation of PRIMARY KEY
constraint ‘PK_Categories’. Cannot insert duplicate key in
object ‘dbo.Categories’.
The statement has been terminated.

Such store exception is typically not meaningful to User Alice namely because; the exception mentions store constructs (tables and primary keys) rather than entity constructs (extents and entity keys). Accordingly, the appropriate context can be easily inferred. The SaveChanges method is an aggregate operator, so the store exception is ambiguous about the specific change causing the violation. In such case, the subject innovation maintains sufficient information in the update pipeline to allow context wrapping of the store exception. Moreover, in this example, the update pipeline can track the cache entry or entries mapped to each store command, wherein

```
// where SqlException.Number = 2627
throw new UniquenessConstraintException(
        “Unique value constraint violation. Modify property
value or exclude entry from list.”,
        innerSqlException, failingEntries);
```

The constraint exception allows user Alice to resolve the collision without any knowledge of the underlying data store or of the mapping from the value layer to the store. In a related example, user Bob's Northwind entity data model includes the notion of a Product entity type and a derived DiscontinuedProduct type. Such user Bob defines an entity set “Products” of type Product. The mapping specification to the Northwind database fails to describe behavior for the DiscontinuedProduct type in the Products extent. It can be a requirement of mappings that the contents of extents are fully mapped, so this is a violation. The resulting exception indicates that there is an incomplete mapping specification, namely:

Underspecified mapping: No mapping was specified for the
following configurations of “Products”:
Type = “DiscontinuedProducts”

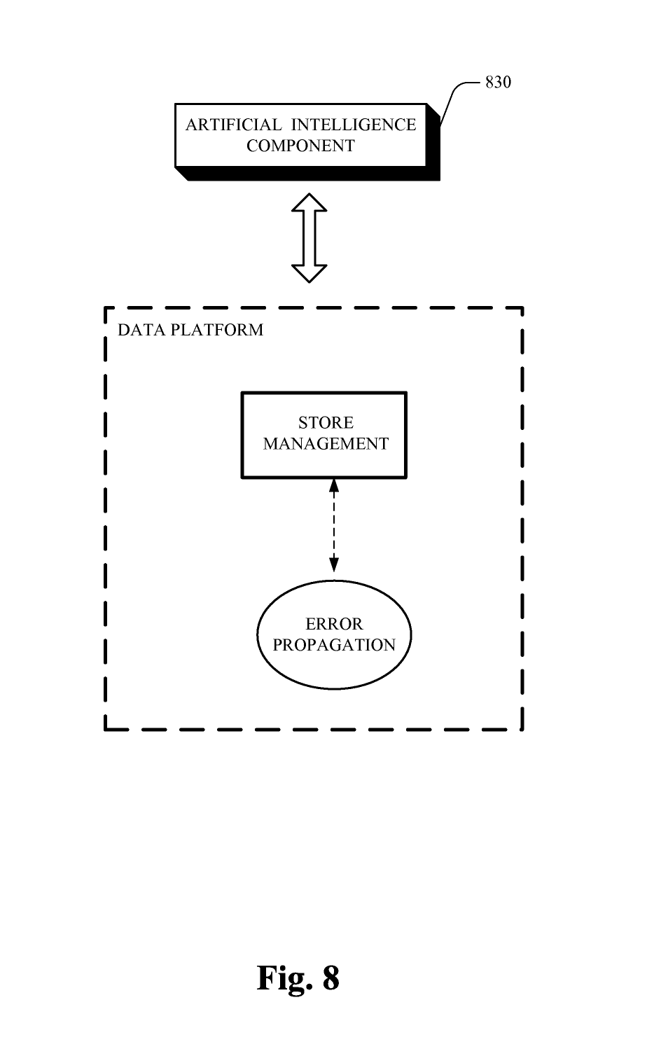

FIG. 8 illustrates an artificial intelligence (AI) component 830 that can be employed to facilitate inferring and/or determining when, where, how to generate an error message in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 830 can employ any of a variety of suitable AI-based schemes as described supra in connection with facilitating various aspects of the herein described innovation. For example, a process for learning explicitly or implicitly how tracing of data to its original should be performed can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

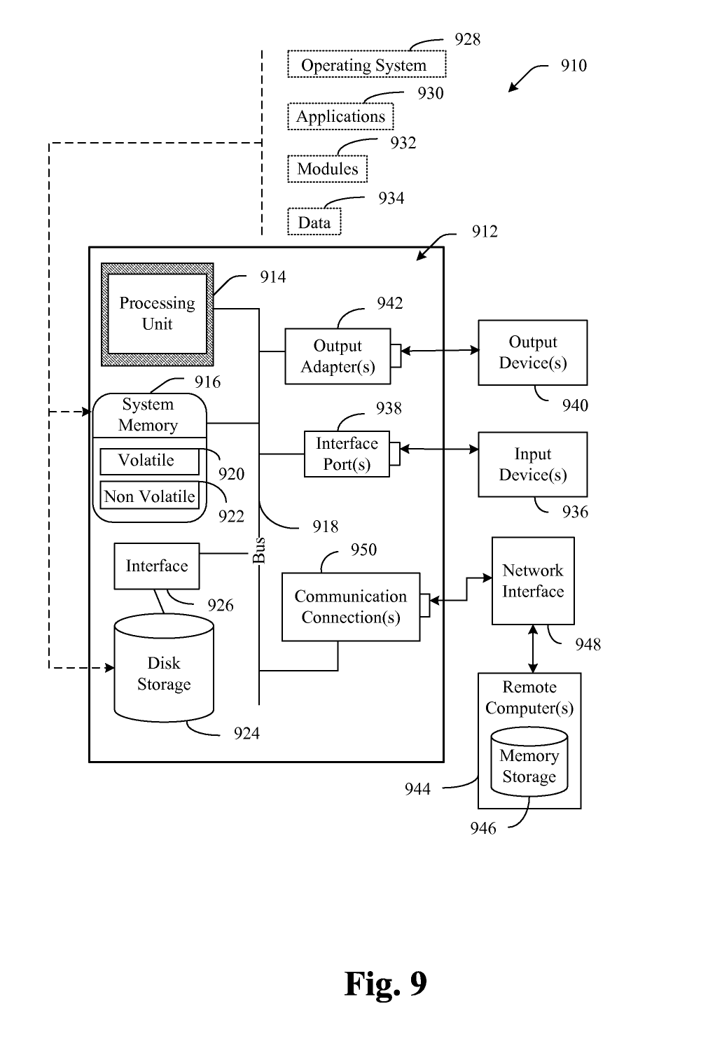

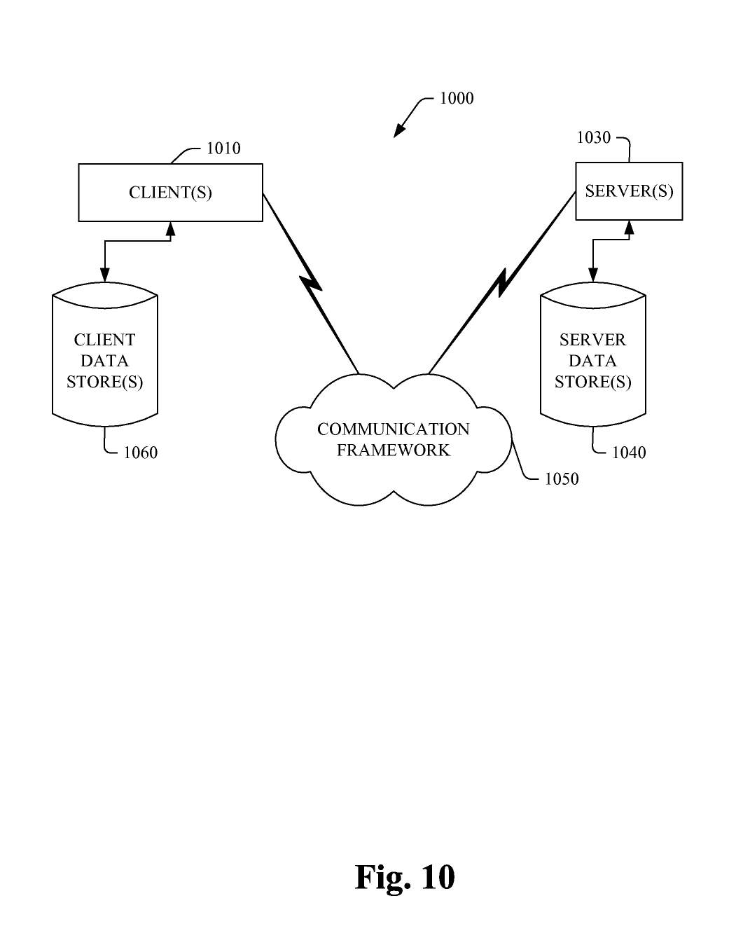

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for implementing an error propagation component in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
An operation defined in an object oriented model that manipulates data in a storage provider(s); and
an error propagation component that presents errors associated with data manipulation in the storage provider in the object oriented model.

2. The computer implemented system of claim 1, the operation associated with a query, and a language of the storage provider is a structured query language.

3. The computer implemented system of claim 2, the query representable by an abstract class.

4. The computer implemented system of claim 3, the abstract class with metadata associated therewith, to identify a return address for data.

5. The computer implemented system of claim 4, the error propagation component further comprising a tracking component that establishes a trail for the data.

6. The computer implemented system of claim 5, the error propagation component further comprising a re-construction component that reconstructs a context of the data.

7. The computer implemented system of claim 5, the object oriented model is an Entity Data Model (EDM).

8. The computer implemented system of claim 5 further comprising a tree structure with nodes that represents the query.

9. The computer implemented system of claim 5 further comprising an artificial intelligence component that infers error propagation.

10. The computer implemented system of claim 9, the tree structure translatable into a structured query language.

11. A computer implemented method comprising the following computer executable acts:
forming an operation as an object model;
manipulating data in a relational store via the operation; and
displaying errors related to data manipulation in form of the object model.

12. The computer implemented method of claim 11 further comprising tracing data associated with the errors to an originating address.

13. The computer implemented method of claim 11, the manipulating act further comprising translating a query into dialect of a relation store.

14. The computer implemented method of claim 13 further comprising representing the query form of a tree structure against a data model platform.

15. The computer implemented method of claim 13 further comprising reconstructing context for the data.

16. The computer implemented method of claim 13 further comprising executing the query against an SQL provider.

17. The computer implemented method of claim 13 further comprising converting data associated with the errors to a form understandable by applications that issue the query.

18. The computer implemented method of claim 13 further comprising representing the query in canonical form against a data model platform.

19. The computer implemented method of claim 18 further comprising accessing metadata to validate the canonical form.

20. A computer implemented system comprising the following computer executable components:
means for representing a query as an object model; and
means for displaying errors related to executing the query in the object model.
